(19) United States
(12) Patent Application Publication
(10) Pub. No.: US 2012/0200900 A1
(43) Pub. Date: Aug. 9, 2012

(54) Imaging Optical Array And Image Reading Device

(75) Inventors: Takashi Takeda, Nagano-ken (JP); Satoshi Kinoshita, Nagano-ken (JP)

(73) Assignee: SEIKO EPSON CORPORATION, Tokyo (JP)

(21) Appl. No.: 13/364,579

(22) Filed: Feb. 2, 2012

(30) Foreign Application Priority Data
Feb. 4, 2011 (JP) 2011-022526

(51) Int. Cl. H04N 1/04

(52) U.S. Cl. 358/484; 358/474

(57) ABSTRACT

An imaging optical array includes a plurality of imaging optical elements, which is arranged in a line in an arrangement direction, each including incidence lens to which light from an object is incident, an emission lens that emits light, and a light guiding portion that connects the incidence lens and the emission lens and that guides the light incident from the incidence lens to the emission lens, and which images an erect equal-magnification image of an object by the incidence lens and the emission lens, in which the plurality of imaging optical elements is integrally formed of a transparent medium in a state where the respective light guiding portions of the plurality of imaging optical elements are arranged in a line in the arrangement direction, and a void between the light guiding portions of the imaging optical elements adjacent to each other is empty in the transparent medium.

### CROSS REFERENCE TO RELATED APPLICATION

The present invention contains subject matter related to Japanese Patent Application No. 2011-022526 filed in the Japanese Patent Office on Feb. 4, 2011, the entire contents of which are incorporated herein by reference.

### BACKGROUND

1. Technical Field

The present invention relates to an imaging optical array in which a plurality of imaging optical elements, which forms an erect equal-magnification image of an object, is arranged in a line, and an image reading device that reads an image of an object using the imaging optical array.

2. Related Art

In an image scanner, a facsimile, a copying machine, a banking terminal device, or the like, a contact image sensor module (hereinafter, abbreviated as a “CIS module”) is used as an image reading device. This CIS module reads an image of an object to be read by irradiating with light the object to be read and detecting light that is emitted from the object to be read at this time with an optical sensor.

In addition, an imaging optical array having a structure in which a plurality of imaging optical elements, which has an imaging magnification of an erect equal-magnification, is arranged in a line is generally used to appropriately guide light from the object to be read to the optical sensor. That is, this imaging optical array images the erect equal-magnification image of the object to be read by imaging the light from the object to be read with each of the plurality of imaging optical elements. In addition, the optical sensor can read the image of the object to be read by detecting the erect equal-magnification image.

However, when the imaging optical array in which the plurality of imaging optical elements is arranged in a line is used, crosstalk, in which light incident to one of the imaging optical elements from the object to be read is deviated to a side of the one imaging optical element and is incident to another adjacent imaging optical element, may occur. When the light, which is incident to another imaging optical element due to the crosstalk, is imaged on this imaging optical element, there is a concern that an erect equal-magnification image of the object to be read may not be appropriately formed.

With respect to this problem, for example, a light shielding member disclosed in JP-A-2008-087185 is effective. In JP-A-2008-087185, a plurality of imaging optical elements having two lenses, respectively, is arranged in a line with a zigzag fashion to make up the imaging optical array. In addition, the light shielding member having holes formed in correspondence with the lenses is disposed between two lenses making up the imaging optical elements. Therefore, a wall surface of the hole of the light shielding member is interposed between two adjacent imaging optical elements. Therefore, the propagation of light, which is incident to one of the imaging optical elements and is deviated to a side, is interrupted by the wall surface. In this manner, the suppressing of the crosstalk is achieved by the light shielding member.

However, in JP-A-2008-087185, the light shielding member is provided separately from the imaging optical elements, each including two lenses. Therefore, there is a concern that an error in a positional alignment between the imaging optical elements and the light shielding member may occur at the time of assembling the imaging optical array, or the positional relationship between the imaging optical elements and the light shielding member may be deviated due to thermal distortion or the like in the imaging optical elements and the light shielding member, which is caused by a temperature variation after assembly, and thereby a function of the light shielding member may not be exhibited appropriately.

### SUMMARY

An advantage of some aspects of the invention is to provide a technology capable of allowing a function of a light shielding member to be appropriately exhibited by stabilizing the positional relationship between imaging optical elements and light shielding member.

According to an aspect of the invention, there is provided an imaging optical array including a plurality of imaging optical elements, which is arranged in a line in an arrangement direction, each including an incidence lens to which light from an object is incident, an emission lens that emits light, and a light guiding portion that connects the incidence lens and the emission lens and that guides the light incident from the incidence lens to the emission lens, and which images an erect equal-magnification image of the object by the incidence lens and the emission lens, in which the plurality of imaging optical elements is integrally formed of a transparent medium in a state where the respective light guiding portions of the plurality of imaging optical elements are arranged in a line in the arrangement direction, and a void between the light guiding portions of the imaging optical elements adjacent to each other is empty in the transparent medium.

In addition, according to another aspect of the invention, there is provided an image reading device including a light source portion that irradiates an object with light; the above-described optical array; and a reading portion that reads an erect equal-magnification image of an object, which is imaged by the imaging optical elements of the imaging optical array.

According to the aspects (the imaging optical array and the image reading device) of the invention, each of the imaging optical elements includes an incidence lens, an emission lens, and a light guiding portion that connects the incidence lens and the emission lens and guides the light incident from the incidence lens to the emission lens. In addition, in the imaging optical array, the plurality of imaging optical elements is formed of a transparent medium in a state where the respective light guiding portions of the plurality of imaging optical elements are arranged in a line in the arrangement direction. However, in this imaging optical array, crosstalk between adjacent imaging optical elements becomes a problem.

Therefore, in the aspects of the invention, a void between the light guiding portions of the imaging optical elements adjacent to each other is empty. Therefore, even when the light incident to the light guiding portion of the imaging optical element through the incidence lens is deviated to a side thereof and moves toward another adjacent imaging optical element, the propagation of the light may be interrupted by the void. In this manner, the crosstalk between the imaging optical elements adjacent to each other may be suppressed. That is, in the aspects of the invention, the void serves as a light shielding member. In addition, the void as the light shielding member may be empty in the transparent medium integrally forming the imaging optical elements. Therefore, it is not necessary to perform a positional adjustment of the imaging optical element and the light shielding member (void) at the time of assembling the imaging optical array, and even when a temperature variation occurs after assembly, it is possible to suppress variations in the positional relationship between the imaging optical elements and the light shielding member (void) to a slight value. Therefore, according to the aspects of the invention, the positional relationship between the imaging optical element and the light shielding member (void) is stabilized, and therefore a function of the light shielding member may be appropriately exhibited.

However, the imaging optical elements may be configured to form an intermediate image at the inside of the light guiding portion. In this configuration, particularly, it is important to suppress the occurrence of the crosstalk in the vicinity of the intermediate image. Therefore, the void may be empty between respective intermediate image forming positions of the imaging optical elements adjacent to each other. Therefore, the occurrence of the crosstalk in the vicinity of the intermediate image is reliably suppressed, and therefore it is possible to realize a preferred imaging characteristic.

In addition, as specific aspects of the void, various aspects may be adopted. Therefore, for example, the void may be a hole having the bottom, which is empty from one external side of the transparent medium to a position between the imaging optical elements adjacent to each other. In addition, the void may be a penetration hole that penetrates the transparent medium at a position between the adjacent imaging optical elements. In addition, the void may be a cavity that is formed between the imaging optical elements adjacent to each other at the inside of the transparent medium.

### BRIEF DESCRIPTION OF THE DRAWINGS

The invention will be described with reference to the accompanying drawings, wherein like numbers reference like elements.

FIG. 1 is a partial cross-sectional perspective view illustrating a schematic configuration of an embodiment of an image reading device according to the invention.

FIG. 2 is a perspective view illustrating a configuration of a lens array according to a first embodiment.

FIG. 3 is light beam diagram of an imaging optical element of the lens array shown in FIG. 2.

FIG. 4 is a schematic diagram illustrating a position of a cavity.

FIG. 5 is a perspective view illustrating a configuration of a lens array according to a second embodiment.

FIG. 6 is a perspective view illustrating a configuration of a lens array according to a third embodiment.

FIG. 7 is a perspective view illustrating a configuration of a lens array according to a fourth embodiment.

FIG. 8 is a partial perspective view illustrating a configuration of a lens array according to a fifth embodiment.

FIG. 9 is a light beam diagram of an imaging optical element provided in the lens array shown in FIG. 8.

FIG. 10 is a diagram illustrating a modification of a shape of the void.

### DESCRIPTION OF EXEMPLARY EMBODIMENTS

### First Embodiment

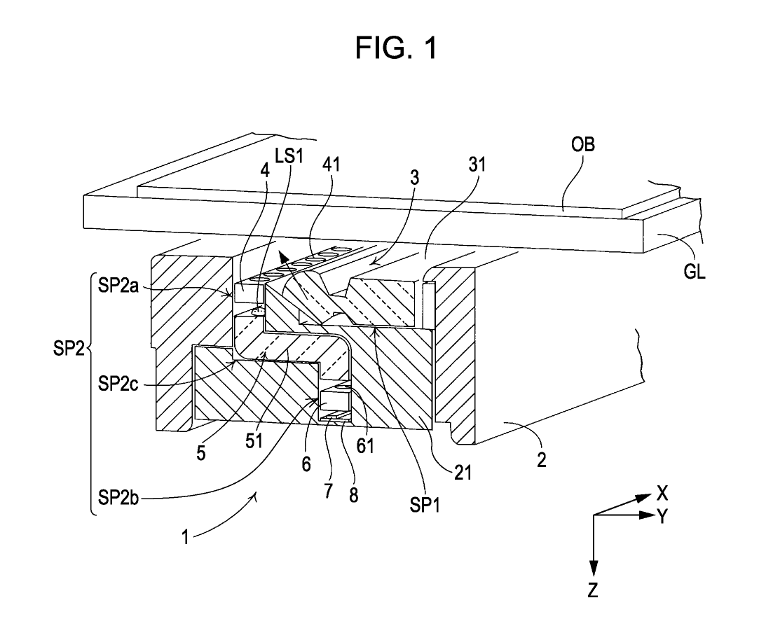

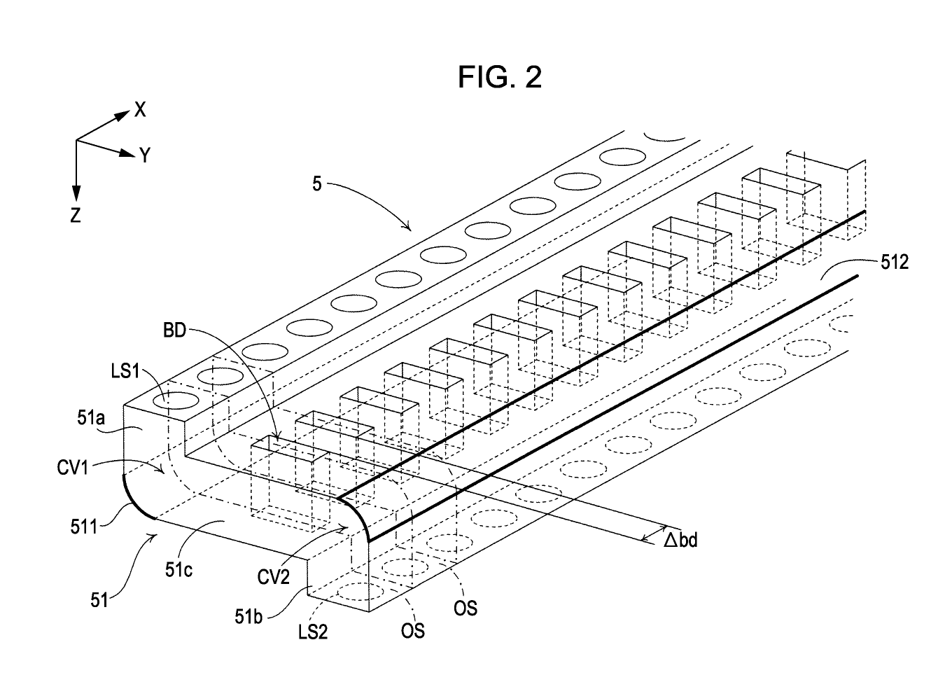

FIG. 1 shows a partial cross-sectional perspective view illustrating a schematic configuration of a CIS module that is an example of an image reading device according to the invention. FIG. 2 shows a perspective view illustrating a configuration of a lens array according to a first embodiment. In FIG. 1, FIG. 2, and in the following description, XYZ orthogonal coordinates are appropriately shown to illustrate the positional relationship of each member. In addition, arrow sides in the coordinate axes are set as positive sides, and opposite sides of the arrow sides in the coordinate axes are set as negative sides. Furthermore, in the following description, the negative side of the Z-direction is regarded as the upper side, the positive side of the Z-direction is regarded as the lower side, the negative side of the Y-direction is regarded as the left side, the positive side of the Y-direction is regarded as the right side, the negative side of the X-direction is regarded as the front side, and the positive side of the X-direction is regarded as the back side.

The CIS module 1 is a device that reads an image printed on a document OB in which the document OB placed on a document glass GL is set as an object to be read. The CIS module 1 is disposed immediately below the document glass GL. The CIS module 1 includes a frame 2 having a substantially rectangular parallelepiped shape that extends longer than the maximum reading range in the X-direction. In the frame 2, a light source portion 3, an incidence-side aperture member 4, a lens array 5, an emission-side aperture member 6, an optical sensor 7, and a printed circuit substrate 8 are disposed.

In the frame 2, a first accommodation space SP1 that accommodates the light source portion 3 illuminating the document OB, and a second accommodation space SP2 that accommodates each of the functional units 4, 5, 6, 7, and 8 for reading an image of the document OB are separated with a separator 21. The first accommodation space SP1 is provided at an upper position in the frame 2. On the other hand, the second accommodation space SP2 is provided so as to surround the first accommodation space SP1 from left side to lower side thereof in a cross-section (hereinafter, referred to as the “sub-scanning cross-section”) including the YZ plane. More specifically, the second accommodation space SP2 includes an upper vertical space SP2a extending in the Z-direction (vertical direction) at the left side of the first accommodation space SP1, a lower vertical space SP2b extending in the Z-direction (vertical direction) at the lower side of the first accommodation space SP1, and a horizontal space SP2c extending in the Y-direction (horizontal direction) so as to connect the lower end of the upper vertical space SP2a and the upper end of the lower vertical space SP2b. In this manner, the second accommodation space SP2, which is bent at a right angle from the upper vertical space SP2a and reaches the horizontal space SP2c, and which is further bent at a right angle from the horizontal space SP2c and reaches the lower vertical space SP2b, is formed.

The light source portion 3 uses an LED (Light Emitting Diode) (not shown) as a light source. The LED emits illumination light from one end in the X-direction of a light guide 31 toward the inside of the light guide 31. As shown in FIG. 1, the light guide 31 is provided on an upper surface of the separator 21 to extend in the X-direction by a length that is substantially equal to the maximum reading range. When being incident to the one end of the light guide 31, the illumination light is emitted toward the document glass GL from each portion of the light guide 31 through a front end (light emission plane) while propagating inside of the light guide 31 toward the other end of the light guide 31, and is emitted to the document OB on the document glass GL. In this manner, the illumination light with a strip-shape extending in the X-direction is emitted to the document OB and is reflected by the document OB.

The above-described upper vertical space SP2a is provided at a position immediately below of the irradiation position of the illumination light, and the incidence-side aperture member 4 is disposed at an upper end of the upper vertical space SP2a. The incidence-side aperture member 4 is provided to extend in the X-direction by a length that is substantially equal to the maximum reading range. In the incidence-side aperture member 4, a plurality of penetration holes 41 is arranged in a line in the X-direction at a predetermined pitch, and functions as an incidence-side aperture with respect to a plurality of first lenses LS1 provided at the lens array 5, respectively.

The lens array 5 is provided to extend in the X-direction by a length that is substantially equal to the maximum reading range, and the entirety of the lens array 5 can be totally inserted in the second accommodation space SP2. The lens array 5 includes first lenses LS1 (incidence-side lenses) that are upwardly convex, second lenses LS2 (emission-side lenses) that are downwardly convex at the lower side and the right side of the first lenses LS1, and a light guiding portion 51 that connects the first and second lenses LS1 and LS2.

In the sub-scanning cross-section, the light guiding portion 51 includes an upper vertical portion 51a that extends in the Z-direction, a horizontal portion 51c that is bent at a right angle from the lower end of the upper vertical portion 51a and extends in the right side direction, and a lower vertical portion 51b that is bent at a right angle from a right end of the horizontal portion and extends downwardly. In this manner, the light guiding portion 51 has a shape that is bent at a right angle at a first bent portion CV1 extending from the upper vertical portion 51a to the horizontal portion 51c, and that is bent at a right angle at a second bent portion CV2 extending from the horizontal portion 51c to the lower vertical portion 51b. On an upper surface of the upper vertical portion 51a of the light guiding portion 51, a plurality of first lenses LS1 is arranged in a line in the X-direction at a predetermined pitch in correspondence with the plurality of penetration holes 41 of the incidence-side aperture member 4 at one-to-one relationship. In addition, on a lower surface of the lower vertical portion 51b of the light guiding portion 51, a plurality of second lenses LS2 is arranged in a line in the X-direction at a predetermined pitch in correspondence with the plurality of first lenses LS1 at one-to-one relationship. In addition, the peripheries of the first and second lenses LS1 and LS2 are rimmed with a light absorptive resin. In addition, light incident to the first lenses LS1 is guided to the second lenses LS2 by the light guiding portion 51.

In addition, a first reflective film 511 and a second reflective film 512 that guide the incident light from the first lenses LS1 to the second lenses LS2 are provided to the light guiding portion 51. The first reflective film 511 is a metallic film that is vapor-deposited on an outer peripheral surface of the first bent portion CV1 that is bent from the upper vertical portion 51a to the horizontal portion 51c of the light guiding portion 51. The first reflective film 511 reflects the illumination light incident from the first lenses LS1 toward the second bent portion CV2. In addition, the second reflective film 512 is a metallic film that is vapor-deposited on an outer peripheral surface of the second bent portion CV2 that is bent from the horizontal portion 51c to the lower vertical portion 51b of the light guiding portion 51. The second bent portion CV2 reflects the illumination light, which is reflected by the first reflective film 511, toward the second lenses LS2. In this manner, the light incident from the first lenses LS1 is reflected by the first and second reflective films 511 and 512, respectively, and is guided to the second lenses LS2.

In this manner, an imaging optical element OS is configured, in which the first lenses LS1, the first reflective film 511, the second reflective film 512, and the second lenses LS2 are arranged in a line in this order. In addition, in FIG. 2, with respect partial imaging optical elements OS, borders thereof are indicated by one-dotted line (imaginary line) to show a unit configuration of the imaging optical element OS. In addition, the lens array 5 has a configuration in which a plurality of imaging optical elements OS is arranged in a line in the X-direction (arrangement direction) with a predetermined pitch.

More specifically, the plurality of imaging optical elements OS is integrally formed of a transparent medium in a state where the respective light guiding portions 51 of the plurality of imaging optical elements OS are arranged in the X-direction with a predetermined pitch, and thereby the lens array 5 is formed. The transparent medium has a light transmitting property with respect to illumination light and includes, for example, a resin, glass, or the like. Here, when integrally forming the lens array 5, for example, separate bodies may be formed by a unit of the imaging optical element, or the first lenses LS1, the light guiding portion 51, and the second lenses LS2 may be separately formed, respectively, and then may be bonded to be integrated. In addition, the entirety of the lens array 5 may be integrally formed without separately forming respective portions.

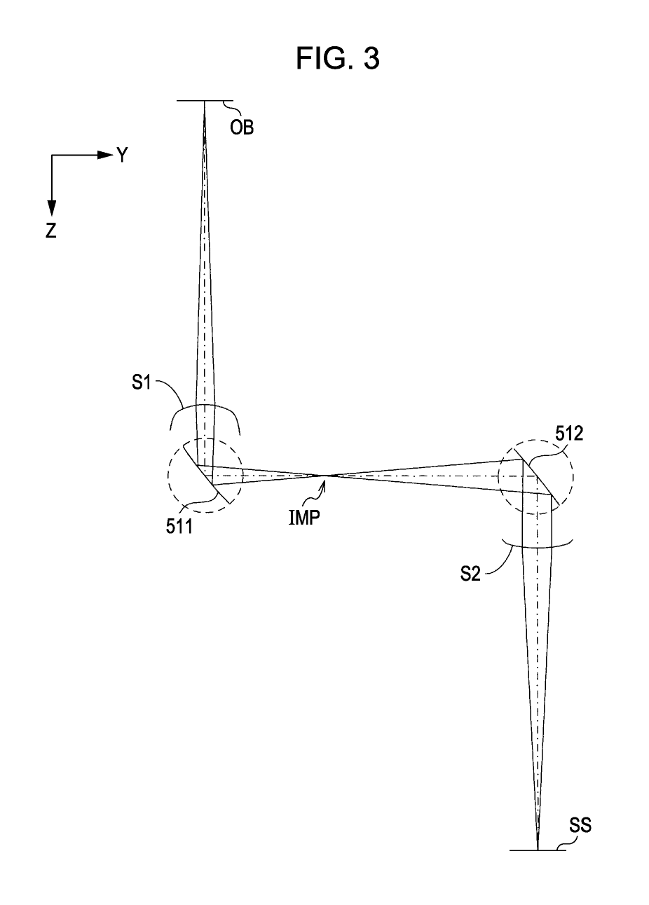

In this manner, since the lens array 5 is integrally formed by the transparent medium in this way, the light incident to the first lenses LS1 propagates inside the transparent medium without passing through an air layer until the light reaches the second lenses through the first and second reflective films 511 and 512 from the first lenses LS1. Therefore, in the imaging optical elements OS, the light incident from the incidence lenses LS1 propagates to the emission lens LS2 without being reflected by an interface with the air layer. As a result, the utilizing efficiency of light is improved. The light, which is transmitted through the imaging optical elements OS of the lens array 5 in this way, is emitted from the second lenses LS2 and then is imaged with a magnification of an erect equal-magnification (FIG. 3).

FIG. 3 shows a light beam diagram of the imaging optical elements of the lens array shown in FIG. 2. As shown in FIG. 3, the light from the document OB is incident to lens planes S1 of the first lenses LS1, propagates in the Z-direction, and then is reflected by the first reflective film 511. Therefore, a propagation direction is changed into the Y-direction and the light propagates toward the second reflective film 512. At this time, due to an operation of a plane shape of the lens planes S1 of the first lenses LS1 and the first reflective film 511, an intermediate image is formed at a position IMP between the first reflective film 511 and the second reflective film 512. In this manner, the light from the intermediate image formed at the inside of the light guiding portion 51 propagates in the Y-direction and then is incident to the second reflective film 512. The light incident to the second reflective film 512 is reflected by the second reflective film 512. Therefore, the propagation direction is changed into the Z-direction and the light propagates toward the lens planes S2 of the second lenses LS2. In this manner, the light reflected by the second reflective film 512 propagates in the Z-direction, is transmitted through the lens planes S2, and is imaged on a sensor plane SS of the optical sensor 7. Therefore, an erect equal-magnification image of the document OB is imaged on the sensor plane SS of the optical sensor 7 located in the Z-direction of the second lenses LS2.

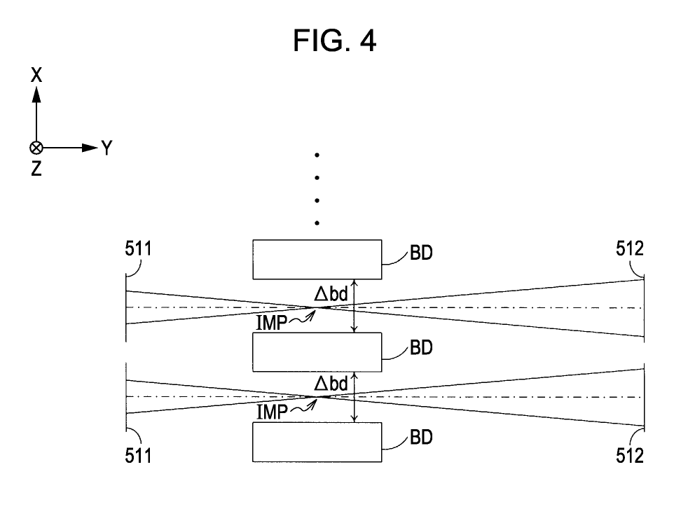

In addition, in this embodiment, in the transparent medium that integrally forms the lens array 5, a void BD between respective light guiding portions 51 of two imaging optical elements OS adjacent to each other may be empty (FIG. 2). The void BD is a penetration hole having a rectangular parallelopiped shape, which vertically penetrates through the lens array 5 (transparent medium) at a position between the two light guiding portions 51 (the horizontal portions 51c thereof) that are adjacent to each other in the X-direction, and is formed to be symmetrical (plane symmetry) with respect to a border (one-dotted line in FIG. 2) of the adjacent light guiding portions 51. In addition, the void BD is filled with a light absorptive resin. In addition, in this embodiment, the void BD may be empty at a position between respective intermediate image formation positions IMP of the imaging optical elements OS adjacent to each other (FIG. 4). Here, FIG. 4 shows a schematic diagram illustrating the position of the void. In this manner, a plurality of voids BD is arranged in a line with an equal distance Δbd in the X-direction.

As described above, the void BD may be empty between the adjacent imaging optical elements OS. Therefore, it is possible to interrupt light that is incident to one imaging optical element OS and then is deviated toward another imaging optical element OS adjacent to the one imaging optical element OS by the void BD (interface thereof). As a result, the generation of crosstalk between adjacent imaging optical elements OS is suppressed. In addition, the lens array 5 may be formed by a technology, for example, an injection molding or the like.

The lens array 5 that is configured in this way is disposed from the middle of the upper vertical space SP2a to the lower vertical space SP2b through the horizontal space SP2c of the second accommodation space SP2. On the other hand, in the lower vertical space SP2b, the emission-side aperture member 6 is disposed to be interposed between the lens array 5 and the optical sensor 7. Similarly to the incidence-side aperture member 4, this emission-side aperture member 6 is also provided to extend in the X-direction by a length that is substantially equal to the maximum reading range and a plurality of penetration holes 61 is arranged in a line in the X-direction. The plurality of penetration holes 61 is provided in correspondence with the plurality of second lenses LS2 at one-to-one relationship, and the respective penetration holes 61 functions as emission-side apertures of the corresponding second lenses LS2.

As described above, in this embodiment, the first lenses LS1 (incidence lenses), the second lenses LS2 (emission lenses), and the light guiding portions 51 that connect these lenses LS1 and LS2 and guide the light incident from the first lenses LS1 to the second lenses LS2 make up the imaging optical elements OS. In the lens array 5, the plurality of imaging optical elements OS is formed of the transparent medium in a state where the respective light guiding portions 51 of the plurality of imaging optical elements OS are arranged in a line in the X-direction (arrangement direction). However, in this lens array 5, crosstalk between the adjacent imaging optical elements OS becomes a problem.

Therefore, in this embodiment, the void BD between the light guiding portions 51 of the imaging optical elements OS adjacent to each other may be empty. Therefore, even when the light incident to the light guiding portion 51 of the imaging optical element OS through the first lens LS1 is deviated to a side thereof and moves toward another adjacent imaging optical element OS, the propagation of the light may be interrupted by the void BD. In this manner, the crosstalk between the imaging optical elements OS adjacent to each other may be suppressed. That is, in this embodiment, the void BD serves as a light shielding member. In addition, the void BD as the light shielding member may be empty in the transparent medium integrally forming the imaging optical elements OS. Therefore, it is not necessary to perform a positional adjustment of the imaging optical element OS and the light shielding member (void BD) at the time of assembling the lens array 5, and even when a temperature variation occurs after assembly, it is possible to suppress variations in the positional relationship between the imaging optical element OS and the light shielding member (void BD) to a slight value. In this manner, according to this embodiment, the positional relationship between the imaging optical element OS and the light shielding member (void BD) is stabilized, and therefore light condensing property or an MTF (Modulation Transfer Function) may be preferable, and a function of the light shielding member (void BD) may be appropriately exhibited.

In addition, in the above-described embodiment, since the void BD, which is empty in the transparent medium forming the lens array 5, functions as the light shielding member, it is not necessary to separately provide a member functioning as the light shielding member in the lens array 5. Therefore, the cost may decrease significantly.

In addition, like this embodiment, in a configuration in which the intermediate image is formed at the inside of the light guiding member 51, particularly, it is important to suppress the occurrence of the crosstalk in the vicinity of the intermediate image. Therefore, in this embodiment, the void BD may be empty between intermediate image forming positions IMP of the respective imaging optical elements OS adjacent to each other. Therefore, the occurrence of the crosstalk in the vicinity of the intermediate image is reliably suppressed, and therefore it is possible to realize a preferred imaging characteristic.

### Second Embodiment

The first embodiment and this second embodiment are different from each other in that whether or not a concave portion CP is formed at both ends of the lens array 5 in the X-direction. Therefore, in the following description, this difference will be mainly described, and corresponding reference numerals will be given to common portions, and description thereof will be appropriately omitted. In addition, since the second embodiment has the same configuration as the first embodiment, it is needless to say that the same effect as the first embodiment can be obtained in the second embodiment.

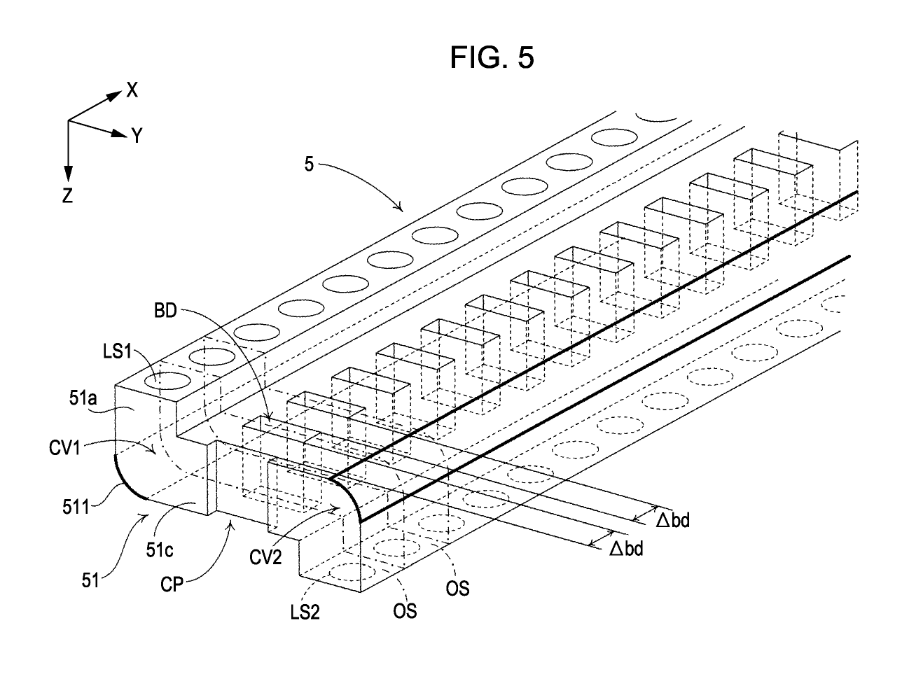

In the first embodiment, the void BD is formed between the imaging optical elements OS adjacent to each other in the X-direction. Therefore, the void BD is disposed at both sides of the imaging optical elements OS in the X-direction, respectively, such that light that passes through between the voids BD is supplied for the imaging by the imaging optical elements OS. That is, it may be assumed that two voids BD, which are disposed with a distance Δbd at both sides of the imaging optical element OS, function as an aperture stop, and thereby give an effect a little on an imaging characteristic of the imaging optical element OS. However, as shown in FIG. 2 and FIG. 3, in regard to the imaging optical elements OS that are located at ends of the lens array 5 in the X-direction, the void BD is provided at one side in the X-direction. Therefore, it is considered that the imaging characteristic may be different a little between the imaging optical elements OS at both ends of the lens array 5 in the X-direction and other imaging optical elements OS. Therefore, it may be configured as shown in FIG. 5.

FIG. 5 shows a perspective view illustrating a configuration of a lens array in the second embodiment. In the second embodiment, in regard to the imaging optical elements OS (end imaging optical elements OS) that are located at ends of the lens array 5 in the X-direction, a concave portion CP is formed at outer side walls in the X-direction. The concave portion CP has a parallelopiped shape that is obtained by dividing the void BD into half at a symmetrical plane thereof (at a border between the adjacent imaging optical elements OS), and is formed to be arranged in the X-direction with the equal distance Δbd together with the plurality of voids BD arranged in a line in the X-direction. Therefore, the void BD and the concave portion CP, which are disposed with the distance Δbd, are provided with the end imaging optical element OS interposed therebetween from the both sides in the X-direction. Therefore, the void BD and the concave portion CP function as an aperture stop of the end imaging optical element OS.

As described above, in the second embodiment, the concave portion CP is provided to the outer side walls in the X-direction of the end imaging optical elements OS, such that the imaging characteristic between the imaging optical elements OS at both ends of the lens array 5 in the X-direction and other imaging optical elements OS may be uniform.

### Third Embodiment

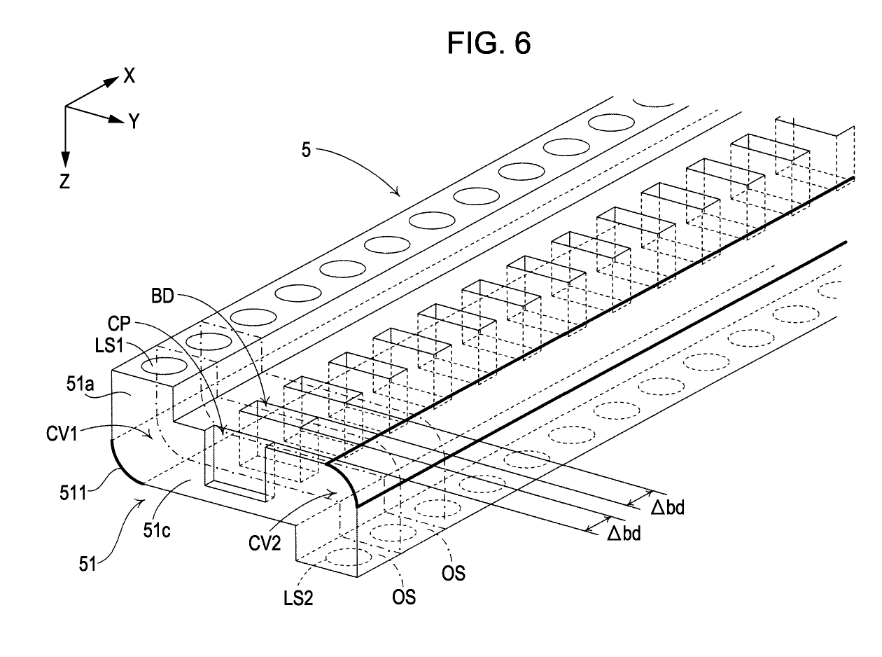

In the above-described embodiments, the void BD is formed as a penetration hole that vertically penetrates the lens array 5 (transparent medium). However, an aspect of the void BD is not limited to this, and may have a configuration shown in FIG. 6. Here, FIG. 6 shows a perspective view illustrating a configuration of a lens array according to a third embodiment. That is, as shown in FIG. 6, in the third embodiment, the void BD is a void having the bottom, which is empty from an upper external side of the light guiding portion 51 (horizontal portion 51c) of the lens array 5 (transparent medium) to a position between the imaging optical elements OS adjacent to each other in the X-direction.

In addition, the main difference between the third embodiment and the above-described embodiments is an aspect of the void BD. Therefore, in the following description, this difference will be mainly described, and corresponding reference numerals will be given to common portions, and description thereof will be appropriately omitted. In addition, since the third embodiment has the same configuration as the above-described embodiments, it is needless to say that the same effect as the above-described embodiments can be obtained.

### Fourth Embodiment

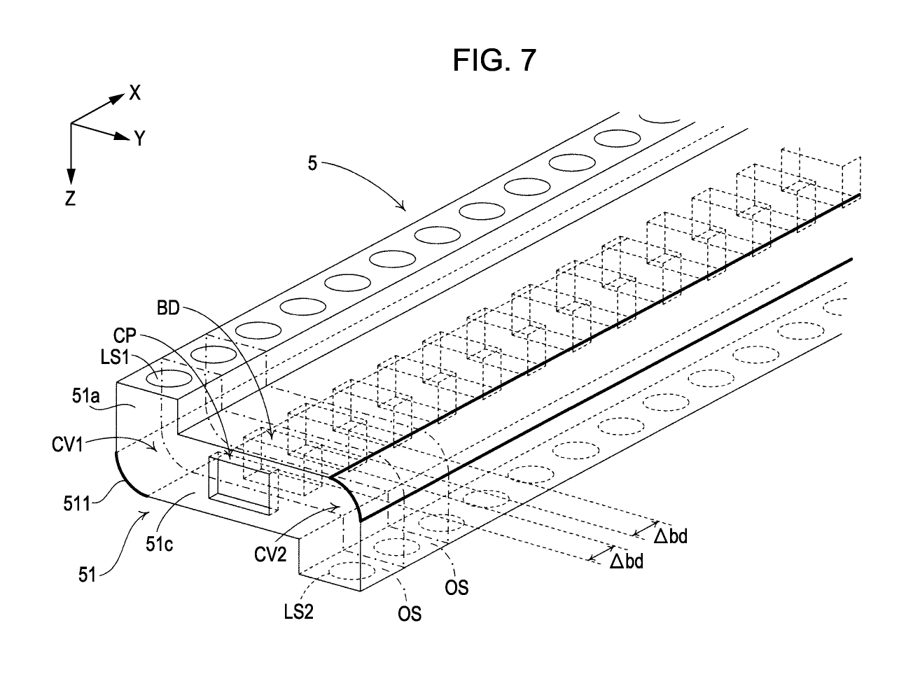

In the above-described embodiments, the void BD is a penetration hole or a hole having the bottom. However, an aspect of the void BD is not limited to this, and may have a configuration shown in FIG. 7. Here, FIG. 7 shows a perspective view illustrating a configuration of a lens array according to a fourth embodiment. That is, as shown in FIG. 7, in the fourth embodiment, the void BD is a cavity that is formed between the light guiding portions 51 (horizontal portions 51c) of the imaging optical elements OS adjacent to each other in the lens array 5 (transparent medium).

In addition, the main difference between the fourth embodiment and the above-described embodiments is an aspect of the void BD. Therefore, in the following description, this difference will be mainly described, and corresponding reference numerals will be given to common portions, and description thereof will be appropriately omitted. In addition, since the fourth embodiment has the same configuration as the above-described embodiments, it is needless to say that the same effect as the above-described embodiments can be obtained.

### Fifth Embodiment

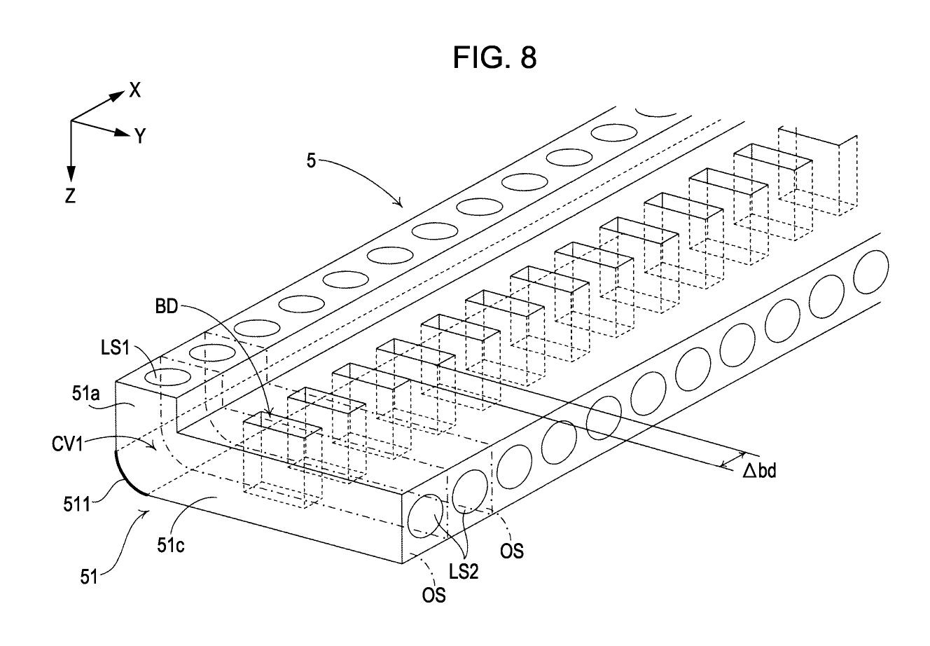

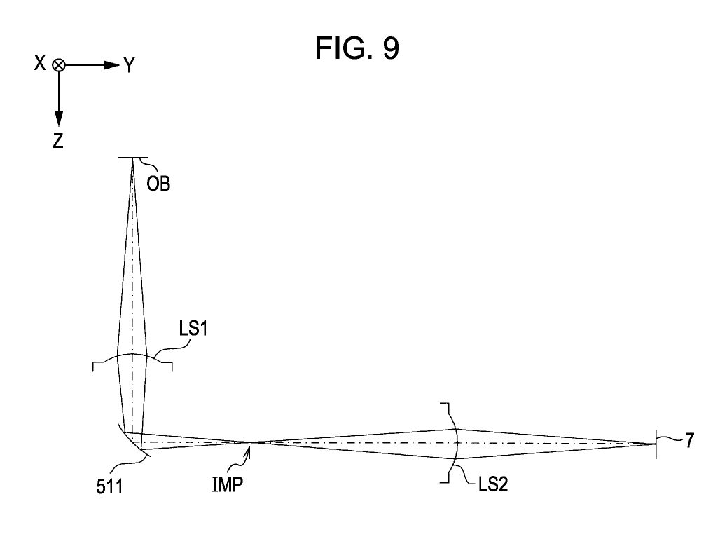

In the above-described embodiments, a case in which the present invention is applied to the lens array 5 having a shape bent at two places is described. However, as shown in FIGS. 8 and 9, the invention may be applied with respect to the lens array 5 having a shape bent at only one place.

FIG. 8 shows a partial perspective view illustrating a schematic configuration of a lens array according to a fifth embodiment. FIG. 9 shows a light beam diagram of the imaging optical element provided to the lens array shown in FIG. 8. The lens array 5 includes first lenses LS1 (incidence-side lenses) that are upwardly convex and are opposite to the document OB (irradiation position LP thereof), second lenses LS2 (emission-side lenses) that are convex toward the right side and are opposite to the optical sensor 7 at the lower side or the right side of the first lenses LS1, and a light guiding portion 51 that connects the first and second lenses LS1 and LS2.

In the sub-scanning cross-section, the light guiding portion 51 includes a vertical portion 51a that extends in the Z-direction, and a horizontal portion 51c that extends from the lower end of the vertical portion 51a in the Y-direction. In this manner, the light guiding portion 51 is bent at a right angle from the X-direction to the Y-direction at a bent portion CV1 that extends from the vertical portion 51a to the horizontal direction 51c. On an upper surface of the vertical portion 51a of the light guiding portion 51, the plurality of first lenses LS1 is arranged in a line in the X-direction at a predetermined pitch in correspondence with a plurality of penetration holes 41 of the incidence-side aperture member 4 at one-to-one relationship. In addition, on a right end face of the horizontal portion 51c of the light guiding portion 51, the plurality of second lenses LS2 is arranged in a line in the X-direction at a predetermined pitch in correspondence with the plurality of first lenses LS1 at one-to-one relationship. In addition, the illumination light incident to the first lenses LS1 is guided to the second lenses LS2 by the light guiding portion 51.

That is, a reflective film 511 that guides the incidence light from the first lenses LS1 to the second lenses LS2 is provided to the light guiding portion 51. The reflective film 511 is a metallic film that is vapor-deposited on an outer peripheral surface of the bent portion CV1 that is bent from the vertical portion 51a to the horizontal portion 51c of the light guiding portion 51. The reflective film 511 reflects light, which is incident from the first lenses LS1 in the Z-direction, in the Y-direction.

The lens array 5 configured in this manner images the light, which is reflected from the document OB at the irradiation position LP of the illumination light, toward the Y-direction (FIG. 9). That is, as shown in FIG. 9, the light that is reflected by the document OB and faces the Z-direction is guided to the reflective film 511 by the first lenses LS1. In addition, the light guided from the document OB to the reflective film 511 is reflected toward the Y-direction by the reflective film 511 and then is made to converge toward the Y-direction by the second lenses LS2. In this manner, the erect equal-magnification image of the document OB is imaged on a sensor plane of the optical sensor 7 that is located in the Y-direction of the second lenses LS2.

Furthermore, according to this embodiment, in the transparent medium that integrally forms the lens array 5, a void BD between respective light guiding portions 51 of two imaging optical elements OS adjacent to each other may be empty (FIG. 8). The void BD is a penetration hole having a rectangular parallelopiped shape, which vertically penetrates through the lens array 5 (transparent medium) at a position between the two light guiding portions 51 (the horizontal portions 51c thereof) that are adjacent to each other in the X-direction, and is formed to be symmetrical (plane symmetry) with respect to a border (one-dotted line in FIG. 8) of the adjacent light guiding portions 51. In addition, in this embodiment, the void BD may be empty at a position between respective intermediate image formation positions IMP of the imaging optical elements OS adjacent to each other. In this manner, a plurality of voids BD is arranged in a line with an equal distance Δbd in the X-direction.

As described above, the void BD may be empty between the adjacent imaging optical elements OS. Therefore, it is possible to reflect light that is incident to one imaging optical element OS and then is deviated toward another imaging optical element OS adjacent to the one imaging optical element OS by the void BD (interface thereof). As a result, the generation of crosstalk between adjacent imaging optical elements OS is suppressed. In addition, the lens array 5 may be formed by a technology, for example, an injection molding or the like.

As described above, in the fifth embodiment, the void BD between the light guiding portions 51 of the imaging optical elements OS adjacent to each other may be empty. In addition, this void BD serves as the light shielding member. Furthermore, the void BD as the light shielding member may be empty in the transparent medium integrally forming the imaging optical element OS. Therefore, it is not necessary to perform a positional adjustment of the imaging optical element OS and the light shielding member (void BD) at the time of assembling the lens array 5, and even when a temperature variation occurs after assembly, it is possible to suppress variations in the positional relationship between the imaging optical element OS and the light shielding member (void BD) to a slight value. In this manner, according to the fifth embodiment, the positional relationship between the imaging optical element OS and the light shielding member (void BD) is stabilized, and therefore light condensing property or an MTF may be preferable, and a function of the light shielding member (void BD) may be appropriately exhibited.

In addition, in the fifth embodiment, since the void BD, which is empty in the transparent medium forming the lens array 5, functions as the light shielding member, it is not necessary to separately provide a member functioning as the light shielding member in the lens array 5. Therefore, the cost may decrease significantly.

In addition, like this embodiment, in a configuration in which the intermediate image is formed at the inside of the light guiding portion 51, particularly, it is important to suppress the occurrence of the crosstalk in the vicinity of the intermediate image. Therefore, in the fifth embodiment, the void BD may be empty between intermediate image forming positions IMP of the respective imaging optical elements OS adjacent to each other. Therefore, the occurrence of the crosstalk in the vicinity of the intermediate image is reliably suppressed, and therefore it is possible to realize a preferred imaging characteristic.

### Others

As described above, in the embodiments, the first lens LS1 corresponds to “incidence lens” of the invention, the second lens LS2 corresponds to “emission lens” of the invention, the light guiding portion 51 corresponds to “light guiding portion” of the invention, the imaging optical element OS corresponds to “imaging optical element” of the invention, the X-direction corresponds to “arrangement direction” of the invention, the void BD corresponds to “void” of the invention, and the lens array 5 corresponds to “imaging optical array” of the invention. In addition, the light source portion 3 corresponds to “light source portion” of the invention, and the optical sensor 7 corresponds to “reading portion” of the invention.

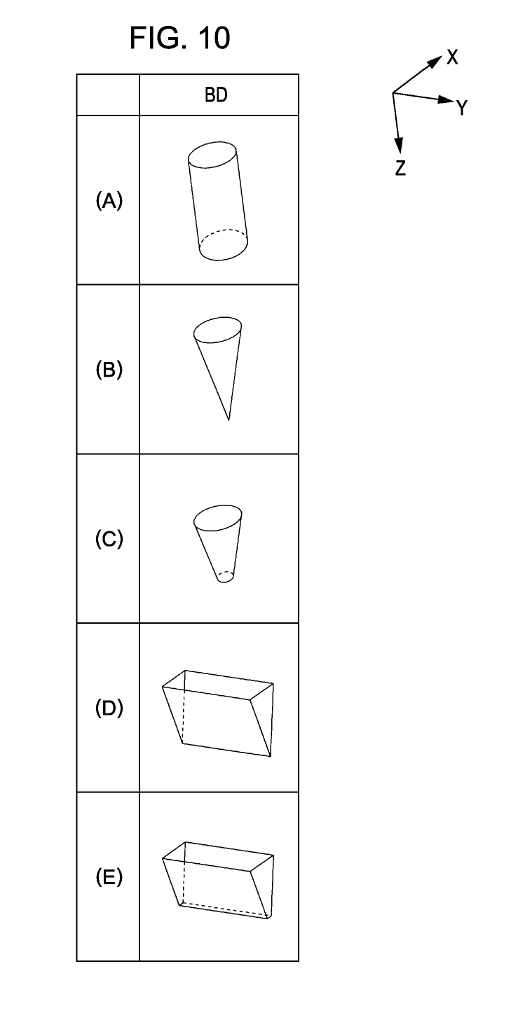

In addition, the present invention is not limited to the above-described embodiment, and various modifications may be made without departing from the scope of the invention in addition to the above-described configurations. For example, in the above-described embodiments, the void BD has a rectangular parallelopiped shape. However, the shape of the void BD is not limited to this, and various modifications may be made. Specifically, for example, shapes shown in column (A) to (E) of FIG. 10 may be adopted. Here, FIG. 10 is a diagram illustrating a modification of the shape of the void. That is, the void BD may have various shapes such as a cylindrical shape (A), a conical shape (B), a truncated conical shape (C), a wedge shape (D), and a shape (E) in which the top portion of the wedge is notched.

In a case where the void BD is formed with the conical shape or the wedge shape shown in columns (B) and (D), the void BD may be formed as a hole having the bottom or a cavity. In addition, in a case where the void BD is formed with the cylindrical shape, the truncated conical shape, or the shape in which the top portion of the wedge is notched as shown in columns (A), (C), and (E), the void may be formed as a penetration hole, a hole having the bottom, or a cavity.

In addition, in the above-described embodiments, the void BD is filled with a light absorptive resin. However, it may be configured to cover a wall surface of the void BD with the light absorptive resin instead of filling the entirety of the inside of the void BD with the light absorptive resin. In addition, it may be configured to fill the void BD with air instead of the light absorptive resin.

In addition, in the above-described embodiment, the void BD is provided between the horizontal portions 51c of the light guiding portions 51 that are adjacent in the X-direction. However, the position at which the void BD is provided is not limited to this and may be various modifications may be made. Therefore, for example, the void BD may be provided between the vertical portions 51a (or the horizontal portion 51b) of the light guiding portions 51 that are adjacent to each other in the X-direction, or the like.

In addition, in the above-described embodiments, the void BD is formed between the position IMP of the intermediate image that is formed by the two adjacent imaging optical element OS. However, the void BD may be formed at a position deviated from the intermediate image formation positions IMP.

In addition, in the above-described embodiments, the bent portions CV1, CV2, and the light guiding portion 51 are bent in a right angle. However, the bent angle of the light guiding portion 51 is not limited to the right angle.

In addition, in the above-described embodiments, light is reflected by the first reflective film 511 and the second reflective film 512 that are metallic films in the imaging optical element OS. However, it may be configured to totally reflect the light at the outer peripheral surfaces of the bent portions CV1 and CV2 by shaping the outer peripheral surfaces of the bent portions CV1 and CV2 so as to satisfy total reflection conditions without providing the metallic films.

In addition, in the above-described embodiments, the lens array 5 is disposed to slip into the lower side of the light source portion 3 from a left side of the light source portion 3 toward the right side in the Y-direction. However, the lens array 5 may be disposed in a reverse direction (toward a left side in the Y-direction from the left side of the light source portion 3) so as not to vertically overlap the light source portion 3.

In addition, in the above-described embodiment, the light source is mounted on the CIS module and light reflected by the document is made to incident to the lens array 5. However, the light source may be disposed at a side that is opposite to the CIS module 1 (lens array 5 thereof) with the document interposed between the CIS module (lens array 5 thereof) the light source, and light, which is emitted from the light source and is transmitted through the document such as a film, may be made to be incident to the lens array 5.

What is claimed is:

1. An imaging optical array, comprising:
a plurality of imaging optical elements, which is arranged in a line in an arrangement direction, each including an incidence lens to which light from an object is incident, an emission lens that emits light, and a light guiding portion that connects the incidence lens and the emission lens and that guides the light incident from the incidence lens to the emission lens, and which images an erect equal-magnification image of the object by the incidence lens and the emission lens,
wherein the plurality of imaging optical elements is integrally formed of a transparent medium in a state where the light guiding portions of the plurality of imaging optical elements are arranged in a line in the arrangement direction, and
a void between the light guiding portions of the imaging optical elements adjacent to each other is empty in the transparent medium.

2. The imaging optical array according to claim 1,
wherein the imaging optical elements form an intermediate image at the inside of the light guiding portion, and
the void is empty between intermediate image forming positions of the respective imaging optical elements adjacent to each other.

3. The imaging optical array according to claim 1,
wherein the void is a hole having a bottom, which is empty from one external side of the transparent medium to a position between the imaging optical elements adjacent to each other.

4. The imaging optical array according to claim 1,
wherein the void is a penetration hole that penetrates the transparent medium at a position between the adjacent imaging optical elements.

5. The imaging optical array according to claim 1,
wherein the void is a cavity that is formed between the imaging optical elements adjacent to each other at the inside of the transparent medium.

6. An image reading device, comprising:
a light source portion that irradiates an object with light;
an imaging optical array including a plurality of imaging optical elements, which is arranged in a line in an arrangement direction, each including an incidence lens to which light from the object is incident, an emission lens that emits light, and a light guiding portion that connects the incidence lens and the emission lens and that guides the light incident from the incidence lens to the emission lens, and which images an erect equal-magnification image of an object by the incidence lens and the emission lens; and
a reading portion that reads an erect equal-magnification image of the object, which is imaged by the imaging optical elements of the imaging optical array,
wherein in the imaging optical array, the plurality of imaging optical elements is integrally formed of a transparent medium in a state where the respective light guiding portions of the plurality of imaging optical elements are arranged in a line in the arrangement direction, and
a void between the light guiding portions of the imaging optical elements adjacent to each other is empty in the transparent medium.

7. The image reading device according to claim 6,
wherein the imaging optical elements form an intermediate image at the inside of the light guiding portion, and
the void is empty between intermediate image forming positions of the respective imaging optical elements adjacent to each other.

8. The image reading device according to claim 6,
wherein the void is a hole having a bottom, which is empty from one external side of the transparent medium to a position between the imaging optical elements adjacent to each other.

9. The image reading device according to claim 6,
wherein the void is a penetration hole that penetrates the transparent medium at a position between the adjacent imaging optical elements.

10. The image reading device according to claim 6,
wherein the void is a cavity that is formed between the imaging optical elements adjacent to each other at the inside of the transparent medium.
